(19) United States
(12) Patent Application Publication
(10) Pub. No.: US 2020/0406080 A1
(43) Pub. Date: Dec. 31, 2020

(54) Sprinkler Head

(71) Applicant: SENJU SPRINKLER CO., LTD., Tokyo (JP)

(72) Inventors: Hisayoshi Ohkoshi, Tokyo (JP); Yoshiki Sasaki, Tokyo (JP); Yuta Watanabe, Tokyo (JP)

(73) Assignee: SENJU SPRINKLER CO., LTD., Tokyo (JP)

(21) Appl. No.: 16/969,756

(22) PCT Filed: Jan. 8, 2019
(86) PCT No.: PCT/JP2019/000211

§ 371 Date: Aug. 13, 2020

(30) Foreign Application Priority Data
Mar. 27, 2018 (JP) 2018-060215

(51) Int. Cl. A62C 37/12; B05B 15/62; B05B 3/02

(52) U.S. Cl. CPC A62C 37/12; B05B 3/02; B05B 15/62

(57) ABSTRACT

A sprinkler head includes a body having a nozzle to be connected to a water supply pipe, the nozzle being provided inside the body; a valve that closes the nozzle in normal times; a pair of frames extending from the body in a direction of water discharge from the nozzle; a main deflector provided at distal ends of the frames; a heat-sensitive disassembling unit provided between the valve and the main deflector; and an assist deflector extending substantially parallel to a virtual plane passing through a center axis of the nozzle and through the frames, the assist deflector being spaced apart from the virtual plane. The heat-sensitive disassembling unit includes a link formed of a plurality of thin plates joined to one another with a low-melting-point alloy, the heat-sensitive disassembling unit further including a bar and a lever that are engaged with the link.

### TECHNICAL FIELD

The present invention relates to a fire-extinguishing sprinkler head.

### BACKGROUND ART

Sprinkler systems are installed in buildings. Such a sprinkler system is automatically activated at the sensing of the heat of fire and sprinkles water to extinguish the fire. A sprinkler head includes a nozzle thereinside. The nozzle is connected to a pipe connected to a water supply source. In normal times, the nozzle is closed. If a fire occurs and the sprinkler head is activated with the heat, the nozzle is opened, whereby water stored in the pipe is discharged from the nozzle. The sprinkler head includes a deflector provided on an extension of the outlet of the nozzle. The deflector scatters water in all directions. When water collides with the deflector, the water is sprinkled over a predetermined range, whereby the fire is suppressed and extinguished.

One example of the sprinkler head configured as above is a frame-type sprinkler head. The frame-type sprinkler head includes a horseshoe-shaped frame having a nozzle inside and extending from a body in the direction of water discharge. The frame is provided with a deflector at a distal end thereof. Water discharged from the nozzle is made to collide with the deflector and is thus scattered in all directions.

A valve that closes the nozzle in normal times is provided between the nozzle and the deflector. The valve is supported by a heat-sensitive disassembling unit. A widely known heat-sensitive disassembling unit is a glass bulb or an element employing a low-melting-point alloy. When the heat-sensitive disassembling unit is activated by the heat of a fire, a phenomenon (lodgement) may rarely occur in which the flow of water generated by the nozzle causes any of components forming the heat-sensitive disassembling unit or the valve to be caught by the deflector.

To prevent the occurrence of lodgement, another sprinkler head includes a spring that urges the valve in a direction deviated from the flow of water (see PTL 1, for example).

On the other hand, a sidewall sprinkler head (see PTL 2, for example) includes, in addition to a deflector, an assist deflector having a flat surface extending substantially parallel to the center axis of the nozzle. When the sprinkler head is activated, any of components forming the heat-sensitive disassembling unit or the valve may rarely be caught in a gap between the deflector and the assist deflector, causing lodgement.

### CITATION LIST

### Patent Literature

PTL 1: Japanese Unexamined Patent Application Publication No. 2006-346497

PTL 2: U.S. Pat. No. 5,727,737

### SUMMARY OF INVENTION

### Technical Problem

In view of the above problem, an object of the present invention is to provide a sidewall sprinkler head configured such that the occurrence of lodgement at the activation of the sprinkler head can be prevented.

### Solution to Problem

To achieve the above object, the present invention provides the following sprinkler head.

Specifically, a sprinkler head includes a body having a nozzle to be connected to a water supply pipe, the nozzle being provided inside the body; a valve that closes the nozzle in normal times; a pair of frames extending from the body in a direction of water discharge from the nozzle; a main deflector provided at distal ends of the pair of frames; a heat-sensitive disassembling unit provided between the valve and the main deflector; and an assist deflector extending substantially parallel to a virtual plane passing through a center axis of the nozzle and through the frames, the assist deflector being spaced apart from the virtual plane. The heat-sensitive disassembling unit includes a link formed of a plurality of thin plates joined to one another with a low-melting-point alloy, the heat-sensitive disassembling unit further including a bar and a lever that are engaged with the link. The lever is positioned in a space across the virtual plane from a space where the assist deflector is positioned.

If the heat-sensitive disassembling unit is positioned in the space across the virtual plane from the space where the assist deflector is positioned, components forming the heat-sensitive disassembling unit fall in a direction away from the virtual plane at the activation of the sprinkler head. Therefore, the occurrence of lodgement can be prevented.

Furthermore, the valve is provided with a hanger including guide portions extending toward the respective frames, the guide portions being positioned in the space across the virtual plane from the space where the assist deflector is positioned. In such a configuration, when the valve is moved by the flow of water discharged from the nozzle at the activation of the sprinkler head, the hanger can be made to collide with the frames and fall in the direction away from the virtual plane. In this process, the valve moves in a direction away from the assist deflector. Therefore, the occurrence of lodgement in which the valve is caught in a gap between the main deflector and the assist deflector can be prevented.

The hanger includes an annular engaging portion engaged with an outer periphery of the valve, and guide portions extending from the engaging portion toward the respective frames. The guide portions are positioned in proximity to or in contact with the respective frames. The hanger may be integrated with the valve. Furthermore, the engaging portion may have a C shape with a part being cut.

Furthermore, the hanger may have a snapping characteristic and may be configured such that two ends of the guide portions bent in the W shape are engaged with the pair of frames, respectively, and the valve body is fitted in the engaging portion positioned between the two ends. In such a configuration, the elasticity of the hanger causes the valve to fall in the direction away from the virtual plane at the activation of the sprinkler head. Therefore, the occurrence of lodgement can be prevented.

The above hanger is applicable not only to a sidewall sprinkler head but also to an upward or downward sprinkler head. Such a sprinkler head includes a body having a nozzle to be connected to a water supply pipe, the nozzle being provided inside the body; a valve that closes the nozzle in normal times; a pair of frames extending from the body in a direction of water discharge from the nozzle; a main deflector provided at distal ends of the pair of frames; and a heat-sensitive disassembling unit provided between the valve and the main deflector. The valve is provided with a hanger including guide portions extending toward the respective frames. The guide portions are positioned in one of spaces on two respective sides of a virtual plane passing through a center axis of the nozzle and through the frames.

### Advantageous Effects of Invention

According to the present invention described above, the occurrence of lodgement in which the valve or any of components forming the heat-sensitive disassembling unit are caught by the deflector at the activation of the sidewall sprinkler head can be prevented.

### BRIEF DESCRIPTION OF DRAWINGS

FIG. 1 is a plan view of a space where sprinkler heads according to the present invention are installed on a wall.

FIG. 2 is a perspective view of a sprinkler head according to the present invention.

FIG. 3 is a front view of the sprinkler head illustrated in FIG. 2.

FIG. 4 is a sectional view taken along line IV-IV illustrated in FIG. 3.

FIG. 5 is an enlarged sectional view of a heat-sensitive disassembling unit.

FIG. 6 includes (a) as a front view of a hanger, and (b) as a sectional view taken along line VI-VI illustrated in FIG. 4.

FIG. 7 includes (a) as a front view of a hanger according to a first modification, and (b) as a sectional view of the hanger according to the first modification taken along line VI-VI.

FIG. 8 includes (a) as a front view of a hanger according to a second modification, and (b) as a sectional view of the hanger according to the second modification taken along line VI-VI.

### DESCRIPTION OF EMBODIMENTS

A sprinkler head S1 according to the present invention includes a body 1, a deflector 2, a valve 3, a heat-sensitive disassembling unit 4, and a hanger 5.

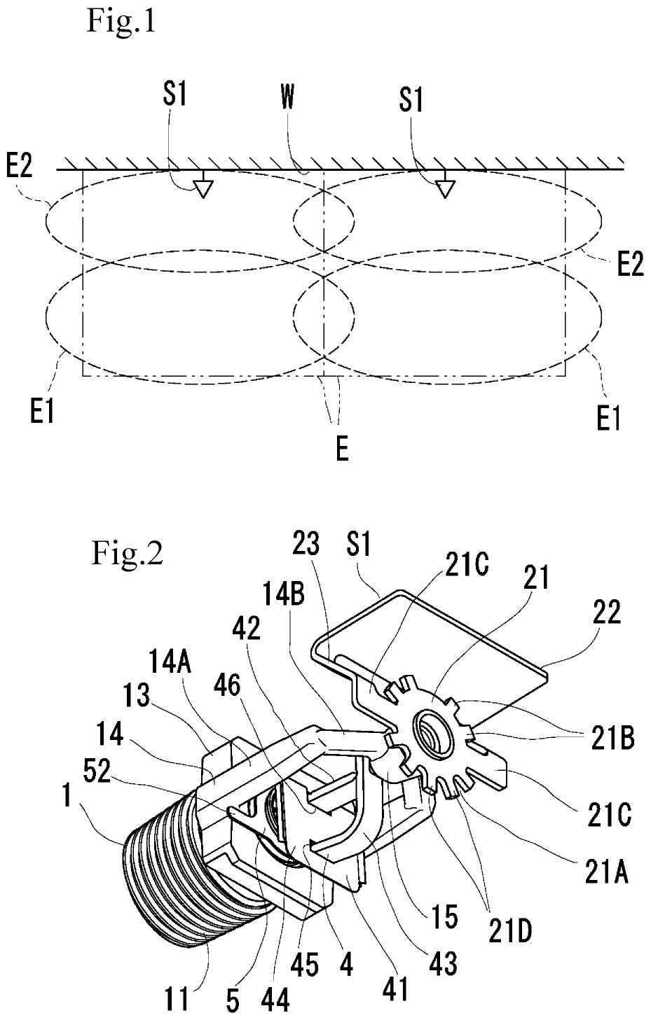

The sprinkler head S1 is a sidewall sprinkler head and is installed on a wall W as illustrated in FIG. 1. The sprinkler head S1 covers a rectangular protection area E, over which water is to be sprinkled evenly.

The body 1 has a hollow shape, with an external thread 11 carved on the outside thereof and a nozzle 12 formed on the inside thereof. The external thread 11 is provided for connection to a pipe provided near or inside a wall of a building. The size of the nozzle 12 is defined within a range of a K factor of 3 to 5.8. The K factor is obtained from the flow rate and the discharge pressure of the nozzle 12. The K factor in the present embodiment is 5.6. The size of the external thread 11, which is connected to the pipe, is NPT ½ or R ½.

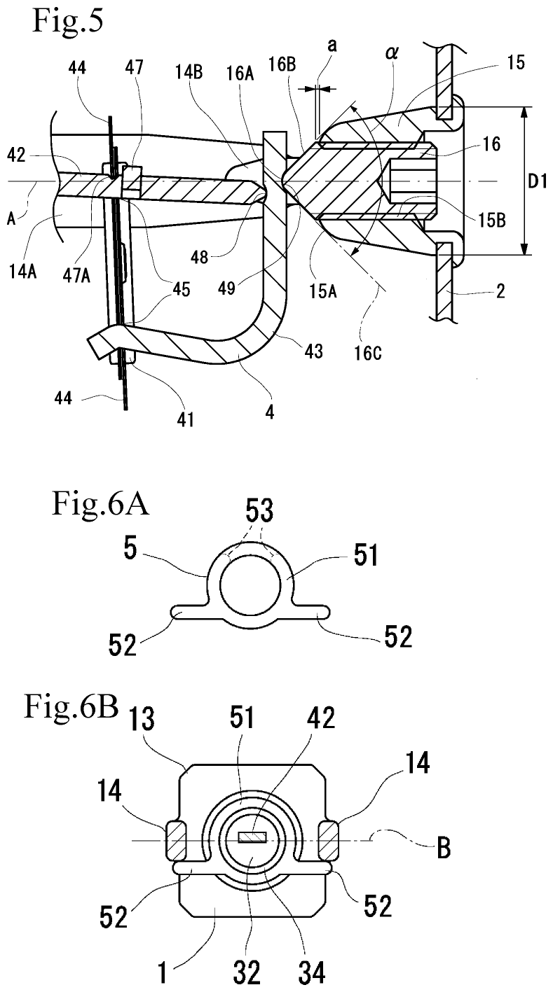

A substantially rectangular base 13 is provided near the outlet of the nozzle 12. A pair of frames 14 extend from the base 13 in a direction of water discharge from the nozzle 12. The frames 14 each include a linear portion 14A (a first arm) extending substantially parallel to a center axis A of the nozzle, and an intersecting portion 14B (a second arm) extending from an end of the linear portion 14A and coupled to a boss 15 provided on the center axis A of the nozzle 12. As illustrated in FIG. 5, the intersecting portion 14B is narrower than the linear portion 14A and has an elliptical sectional shape.

The boss 15 has a tapered round columnar shape. The deflector 2 is provided at an end of the boss 15. A diameter Dl of the boss 15 on a side where the boss 15 is in contact with the deflector 2 is 9 to 10 mm. The outside diameter of the boss 15 at an end on a side nearer to the nozzle 12 is smaller than the diameter Dl on the side nearer to the deflector 2. An outer peripheral end 15A of the boss 15 on the side nearer to the nozzle 12 has a curved surface with a radius of curvature of 1 mm to 3 mm. In the present embodiment, the radius of curvature is 2 mm.

The boss 15 has an internal thread 15B carved on the inside thereof. An impression screw 16 is screwed into the boss 15. The impression screw 16 has a pointed tip 16A with an inclined surface 16B. The tip 16A faces toward the nozzle 12. The inclined surface 16B is at an angle α of 80° to 100°. In the present embodiment, the angle α is 90°. The tip 16A has a spherical top with a spherical radius of preferably 2 mm or smaller. In the present embodiment, the spherical radius is 1 mm or smaller.

The impression screw 16 has a function of pressing the valve 3 toward the nozzle 12 with the heat-sensitive disassembling unit 4 in between. In FIG. 5, an extension 16C extended along the inclined surface 16B around the tip 16A of the impression screw 16 is in proximity to or in contact with the curved surface at the outer peripheral end 15A of the boss 15. Therefore, water running along the surface of the tip 16A and being about to pass the outer peripheral end 15A is not hindered from running along the outer peripheral end 15A, whereby the occurrence of turbulent flow is prevented. In the above configuration, an interval a between the inclined surface 16B of the impression screw 16 and an end face of the boss 15 on the side nearer to the nozzle 12 is set to 2 mm or smaller, more preferably 1 mm or smaller. If the interval is greater than the above, the probability of occurrence of turbulent flow increases.

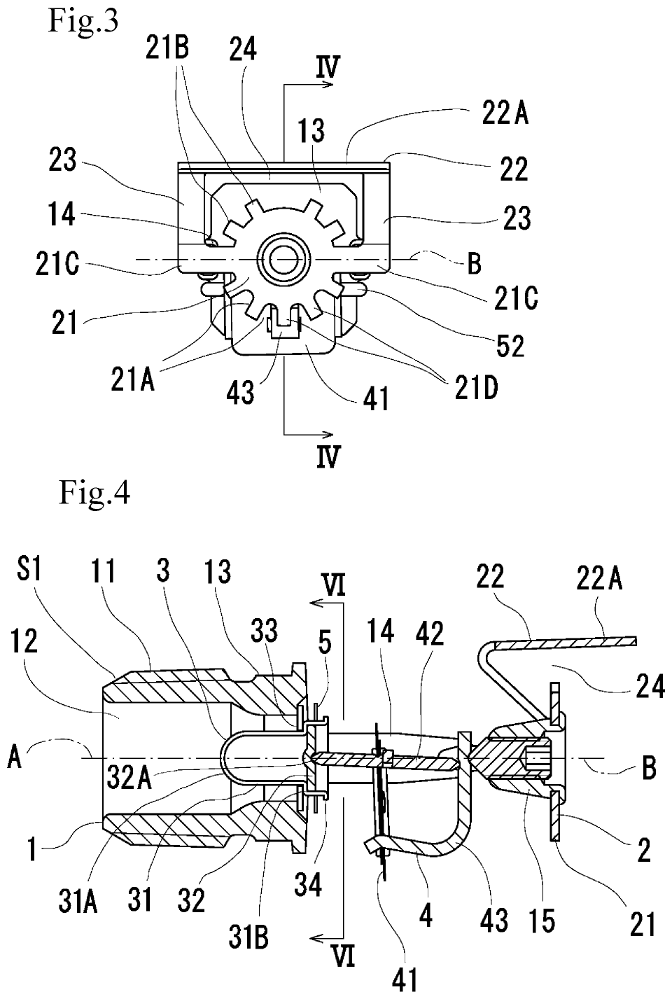

The deflector 2 illustrated in FIGS. 2 to 4 includes a main deflector 21 intersecting the center axis A of the nozzle, and an assist deflector 22 provided near the main deflector 21. The main deflector 21 is provided at the end of the boss 15 and has a substantially disc shape. The main deflector 21 has a plurality of slits 21A and projections 21B at the peripheral edge thereof.

The assist deflector 22 has a rectangular flat surface 22A extending near the main deflector 21 and substantially parallel to the center axis A of the nozzle. The assist deflector 22 is substantially parallel to or inclined upward by several degrees with respect to a virtual plane B that passes through the center axis A of the nozzle and through the pair of frames 14. The assist deflector 22 is spaced apart from the virtual plane B.

The main deflector 21 includes extended portions 21C extending in the virtual plane B and being longer than the projections 21B. The extended portions 21C are continuous with respective bent portions 23 connected to the assist deflector 22, thereby coupling the main deflector 21 and the assist deflector 22 to each other. As illustrated in FIG. 4, the bent portions 23 are each bent from the main deflector 21 toward the nozzle 12. The flat surface 22A of the assist deflector 22 is positioned on an extension of the plane of the main deflector 21 in such a manner as to intersect the extension. A gap 24 is provided between the main deflector 21 and the assist deflector 22. The gap 24 allows the water discharged from the nozzle 12 to be supplied to the assist deflector 22.

In the drawings, water flowing above the virtual plane B collides with the main deflector 21. The water flows along the projections 21B in such a manner as to be dispersed away from the center axis A of the nozzle and is guided toward the assist deflector 22. The water then passes the gap 24, reaches the assist deflector 22, flows along the flat surface 22A, and is sprinkled over a zone denoted by E1, which is farther from the sprinkler head S1, in the protection area E.

Meanwhile, water flowing below the virtual plane B reaches the main deflector 21, is dispersed in directions away from the center axis A of the nozzle by slits 21A and fins 21C each provided between adjacent ones of the slits 21A, and is sprinkled over a zone denoted by E2, which is nearer to the sprinkler head S1, in the protection area E.

In normal times, the valve 3 covers the outlet of the nozzle 12. The valve 3 includes a valve cap 31, a disc 32, and a disc spring 33. The valve cap 31 has a bottomed cylindrical shape with one end thereof forming a spherical bottom portion 31A. The other end of the valve cap 31 has an increased diameter, forming a step 31B.

The disc 32, which is a circular plate, is placed on the inner peripheral side of the step 31B. The disc 32 has a recess 32A in the center thereof. The recess 32A is engaged with one end of a bar 42 included in the heat-sensitive disassembling unit 3.

The disc spring 33 is anchored on the outer peripheral side of the step 31B by inserting the valve cap 31 into the disc spring 33 from the bottom portion 31A. The surface of the disc spring 33 is coated with fluorocarbon resin. The outer peripheral edge of the disc spring 33 is positioned at the outlet end of the nozzle 12. Screwing the impression screw 16 into the boss 15 along the internal thread 15B causes the heat-sensitive disassembling unit 4 to press the disc spring 33, whereby the disc spring 33 is squashed while undergoing elastic deformation. In this process, the fluorocarbon resin serves as a sealing material and thus seals the nozzle 12.

The heat-sensitive disassembling unit 4 includes a link 41, the bar 42, and a lever 43. The link 41 is a heat-sensitive body activated with the heat of fire and includes two thin metal plates 44 that are joined to each other with a low-melting-point alloy. The low-melting-point alloy used here has a melting point within a range of 60 to 200° C. In general, a low-melting-point alloy having a melting point of 72° C. or 96° C. is used.

The two metal plates 44 each have a substantially square shape with a hole 45 at one end thereof and a rectangular-U-shaped cut 46 at the other end thereof. The two metal plates 44 are joined to each other with a low-melting-point alloy. Specifically, the hole 45 of one of the metal plates 44 and the cut 46 of the other metal plate 44 are made to coincide with each other. After the above joining, the bar 42 and the lever 43 are inserted into the two holes 45 of the link 41, respectively (see FIG. 5).

The bar 42 has a strip-like shape with one end being engaged with the disc 32 of the valve 3 at the outlet of the nozzle 12, and the other end being engaged with an end of the lever 43. As described above, the bar 42 extends through the hole 45 of the link 41. The bar 42 has a projection 47 in a middle part thereof. The link 41 is anchored in a groove 47A provided near the projection 47.

The lever 43 is a long narrow plate that is bent in a substantially L shape. As described above, the one end of the lever 43 extends through the hole 45 of the link 41. The other end of the lever 43 is engaged with the bar 42. The lever 43 has a groove 48 with which an end of the bar 42 is engaged.

The lever 43 has a recess 49 on a side thereof opposite the side having the groove 48. The recess 49 is positioned nearer to the other end of the lever 43 than the groove 48. The impression screw 16 is in contact with the recess 49. When the tip of the impression screw 16 is pressed into the recess 49 of the lever 43, a force acts on the lever 43 to rotate the lever 43 about the groove 48, in which the bar 42 is anchored. However, since the one end of the lever 43 extends through the hole 45 of the link 41, the lever 43 is prevented from rotating. Hence, the link 41, the bar 42, and the lever 43 forming the heat-sensitive disassembling unit 4 are kept engaged with one another. Furthermore, the impression screw 16 keeps pressing the valve 3 toward the nozzle 12 with the heat-sensitive disassembling unit 4 in between.

As illustrated in FIG. 4, the heat-sensitive disassembling unit 4 is positioned in a space across the virtual plane B from a space where the assist deflector 22 is positioned. Note that the lever 43 is displaced significantly in a direction in which the link 41 is split at the activation of the sprinkler head S1. Therefore, the lever 43 is positioned in the space across from the space where the assist deflector 22 is positioned. Thus, when the sprinkler head S1 is activated, the link 41, the bar 42, and the lever 43 are thrown in a direction away from the assist deflector 22. Therefore, the occurrence of lodgement in which any of the foregoing components are caught in the gap 24 between the main deflector 21 and the assist deflector 22 can be prevented.

In the sprinkler head S1 configured as above, the assist deflector 22 is positioned on a side nearer to the ceiling, while the heat-sensitive disassembling unit 4 is positioned on a side nearer to the floor. When the heat-sensitive disassembling unit 4 is disassembled at the activation of the sprinkler head S1, the components forming the heat-sensitive disassembling unit 4 fall off toward the floor with the force of the water discharged from the nozzle 12 and under their own weights. That is, the components move in the direction away from the assist deflector 22.

The hanger 5 illustrated in FIG. 6 includes an annular engaging portion 51 and guide portions 52 extending from the engaging portion 51 toward the respective frames 14. The valve cap 31 is fitted in the engaging portion 51. The inside diameter of the engaging portion 51 is substantially the same as the outside diameter of the valve cap 31 on the side where the disc 32 is fitted, and is smaller than the outside diameter of a flange 34 provided at an open end of the valve cap 31. The hanger 5 is set on the valve cap 31 before the disc spring 33 is fitted on the valve cap 31.

Distal ends of the respective guide portions 52 are positioned near the respective frames 14 and in the space across the virtual plane B from the space where the assist deflector 22 is positioned. Furthermore, the guide portions 52 are positioned in a space on a side of the virtual plane B where the lever 43 is positioned. A distance L between the distal ends of the respective guide portions 52 is greater than a distance Lf between the pair of frames 14. When the sprinkler head S1 is activated, the guide portions 52 move along the respective frames 14. Therefore, the hanger 5 and the valve 3 are prevented from moving upward, in the drawing, with respect to the frames 14. Thus, the occurrence of lodgement in which the valve 3 is caught in the gap 24 provided in the deflector 2 is prevented.

Now, an operation of the sprinkler head S1 in case of fire will be described.

In normal times, the sprinkler head S1 illustrated in FIG. 1 is connected to a pipe, not illustrated, screwed on the external thread 11 thereof. The inside of the nozzle 12 is filled with pressurized water. The nozzle 12 is closed by the valve 3 and the heat-sensitive disassembling unit 4.

If a fire occurs and the low-melting-point alloy of the link 41 melts, the lever 43 rotates, whereby the metal plate 44 engaged with the lever 43 is stripped off the metal plate 44 engaged with the bar 42. Consequently, the engagements in the heat-sensitive disassembling unit 4 are disabled. That is, the link 41, the bar 42, and the lever 43 are disengaged from one another, and the valve 3 that has been supported by the bar 42 drops off the nozzle 12, whereby the nozzle 12 is opened.

In this process, the flow of water discharged from the nozzle 12 moves the valve 3 and the hanger 5 such that the guide portions 52 move while being in contact with or in proximity to the frames 14. Eventually, the valve 3 and the hanger 5 are thrown to the outside of the sprinkler head S1, otherwise the guide portions 52 that have received the force exerted by the flow of water collide with the frames 14 and bounce back. Eventually, the valve 3 and the hanger 5 are thrown to the outside of the sprinkler head S1.

The water discharged from the nozzle 12 collides with the main deflector 21 and is sprinkled over the zone E2, which is nearer to the sprinkler head S1. Meanwhile, water that has passed the gap 24 and reached the assist deflector 22 flows along the flat surface 22A of the assist deflector 22 and is accelerated, thereby being sprinkled over the zone E1, which is farther from the sprinkler head S1.

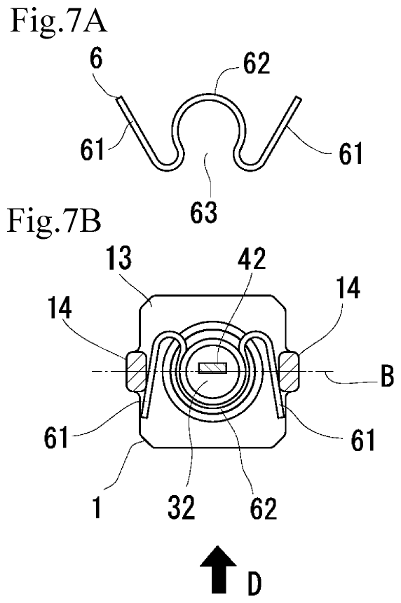

A first modification of the above hanger is illustrated in FIG. 7. A hanger 6 illustrated in FIG. 7 is formed of a piece of snapping wire. The hanger 6 is bent in a substantially W shape, with two ends 61 thereof functioning as guide portions and being engaged with the pair of frames 14. The hanger 6 includes a bent portion 62 in a middle part thereof. The bent portion 62 functions as an engaging portion and receives the valve 3 fitted therein. The bent portion 62 has an open part 63 from which the valve cap 31 is insertable into the bent portion 62.

Before the hanger 6 is set in the sprinkler head S1, the interval between the ends 61 is wider than the interval between the pair of frames 14. Once the hanger 6 is anchored by the frames 14, the ends 61 urge the frames 14.

The hanger 6 is set in the sprinkler head S1 as follows. First, the valve 3 and the heat-sensitive disassembling unit 4 are set in the body 1 of the sprinkler head S1. Then, the hanger 6 is anchored to the frames 14 while the valve cap 31 is fitted into the bent portion 62. The hanger 6 is made to advance between the link 41 and the valve 3 in a direction indicated by arrow D in FIG. 7(b) (in a direction perpendicular to the center axis A of the nozzle), with the open part 63 facing toward the bar 42. Then, the ends 61 interfere with the respective frames 14. Therefore, the hanger 6 elastically deforms such that the ends 61 thereof move toward each other. Consequently, the open part 63 of the bent portion 62 is widened.

As the hanger 6 is further moved in the direction of arrow D, the valve cap 31 passes the open part 63 and enters the bent portion 62. When the hanger 6 is released in the above state, the two ends 61 of the hanger 6 are anchored to the respective frames 14, whereby the valve cap 31 is retained in the bent portion 62. Thus, the fitting of the hanger 6 to the sprinkler head S1 is complete.

The ends 61 of the hanger 6 are urged in a direction opposite to the direction of arrow D. Therefore, when the sprinkler head S1 is activated, the hanger 6 retaining the valve 3 in the bent portion 62 is pushed in a direction away from the frames 14 by the flow of water discharged from the nozzle 12 and is thrown to the outside of the sprinkler head S1.

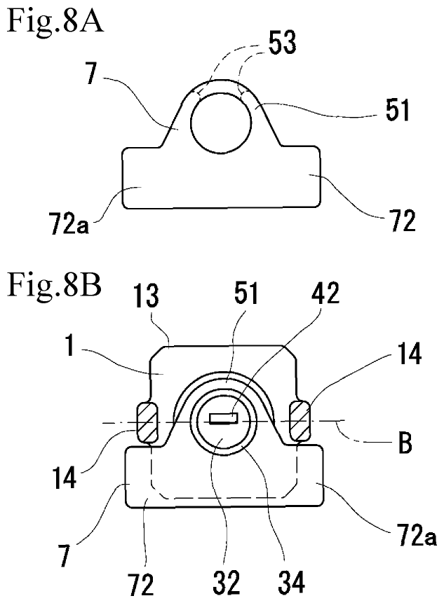

Another modification of the hanger is illustrated in FIG. 8 as a second modification of the hanger. A hanger 7 illustrated in FIG. 8 includes an annular engaging portion 51, as with the hanger 5 illustrated in FIG. 6. The inside diameter of the engaging portion 51 is substantially the same as the outside diameter of the valve cap 31 on the side where the disc 32 is fitted, and is smaller than the outside diameter of the flange 34 provided at the open end of the valve cap 31. The hanger 5 is set on the valve cap 31 before the disc spring 33 is fitted on the valve cap 31.

Guide portions 72 extend from the engaging portion 51 toward the respective frames 14. Distal ends of the respective guide portions 72 are positioned near the respective frames 14 and in the space across the virtual plane B from the space where the assist deflector 22 is positioned. Furthermore, the guide portions 52 are positioned in the space on the side of the virtual plane B where the lever 43 is positioned. The guide portions 72 each has a flat surface 72a. The flat surface 72a extends in a direction away from the virtual plane B. When the sprinkler head S1 is activated, the flat surfaces 72a receive the flow of water discharged from the nozzle and thus move parallel to the frames 14. The flat surfaces 72a then collide with the respective intersecting portions 14B of the frames 14. Eventually, the hanger 7 is thrown out in the direction away from the virtual plane B (downward in the drawing).

The embodiment of the present invention is as described above. Now, other configurations and effects thereof will be described.

The guide portions 52 of the hanger 5 and the valve cap 31 described above may be integrated with each other. If a part of the engaging portion 51, which has an annular shape, between broken lines 53 illustrated in FIG. 6(a) is removed to provide a cut, the hanger 5 can be fitted to the valve 3 after the valve 3 and the heat-sensitive disassembling unit 4 are set in the sprinkler head S1.

While the above embodiment concerns a sidewall sprinkler head, the hanger according to the present invention is applicable not only thereto but also to a downward sprinkler head or an upward sprinkler head.

### REFERENCE SIGNS LIST

1 body
2 deflector
3 valve
4 heat-sensitive disassembling unit
5, 6, 7 hanger
12 nozzle
14 frame
15 boss
21 main deflector
21A slit
21B projection
21C extended portion
21D fin
22 assist deflector
23 bent portion
24 gap
31 valve cap
32 disc
33 disc spring
41 link
42 bar
43 lever
51 engaging portion
52, 72 guide portion
61 end
62 bent portion
A center axis of nozzle
B virtual plane

1-11. (canceled)

12. A sprinkler head comprising:
a body having a nozzle to be connected to a water supply pipe, the nozzle being provided inside the body;
a valve that closes the nozzle in normal times;
a pair of frames extending from the body in a direction of water discharge from the nozzle;
a main deflector provided at distal ends of the pair of frames; and
a heat-sensitive disassembling unit provided between the valve and the main deflector,
wherein the valve is provided with a hanger including guide portions extending toward the respective frames, and
wherein the guide portions are positioned in one of spaces on two respective sides of a virtual plane passing through a center axis of the nozzle and through the frames.

13. The sprinkler head according to claim 12,
wherein the hanger includes an annular engaging portion engaged with an outer periphery of the valve.

14. The sprinkler head according to claim 12,
wherein the hanger is integrated with the valve.

15. The sprinkler head according to claim 13,
wherein the engaging portion has a C shape with a part being cut.

16. The sprinkler head according to claim 12,
wherein the hanger has a snapping characteristic and is bent in a substantially W shape, two ends of the W shape serving as the guide portions and being engaged with the respective frames, the valve being fitted in the engaging portion, the engaging portion having a curved shape and being positioned between the guide portions.

17. The sprinkler head according to claim 12,
wherein the valve has a cylindrical shape with a bottom,
wherein a side of the valve that is nearer to the bottom is positioned in the nozzle,
wherein one end of the heat-sensitive disassembling unit is engaged with an open side of the valve, and
wherein the open side of the valve is fitted in the engaging portion.

18. The sprinkler head according to claim 12,
wherein the heat-sensitive disassembling unit includes a link formed of a plurality of thin plates joined to one another with a low-melting-point alloy, the heat-sensitive disassembling unit further including a bar and a lever that are engaged with the link.

19. The sprinkler head according to claim 18,
wherein the guide portions are positioned in a space on a side of the virtual plane where the lever is positioned.

20. The sprinkler head according to claim 12,
wherein the guide portions each have a flat surface extending in a direction away from the virtual plane.

21. The sprinkler head according to claim 12,
wherein the sprinkler head further comprises an assist deflector being spaced apart from the virtual plane.

22. The sprinkler head according to claim 18,
wherein the sprinkler head further comprises an assist deflector being spaced apart from the virtual plane.

23. The sprinkler head according to claim 22,
wherein the lever is positioned in a space across the virtual plane from a space where the assist deflector is positioned.

24. The sprinkler head according to claim 21,
wherein the valve is provided with the hanger in the space across the virtual plane from the space where the assist deflector is positioned.
